(19) United States
(12) Patent Application Publication
(10) Pub. No.: US 2011/0194937 A1
(43) Pub. Date: Aug. 11, 2011

(54) PRELOADED BEARING FOR ROTOR BLADE

(75) Inventor: John A. Violette, Granby, CT (US)

(73) Assignee: ROTATING COMPOSITE TECHNOLOGIES, LLC, Kensington, CT (US)

(21) Appl. No.: 13/021,976

(22) Filed: Feb. 7, 2011

Related U.S. Application Data
(60) Provisional application No. 61/301,800, filed on Feb. 5, 2010.

(51) Int. Cl. B64C 11/20; F16C 23/10

(52) U.S. Cl. 416/131; 384/563

(57) ABSTRACT

A rotor for a propulsive thrust device comprises a hub having a peripheral surface; a plurality of rotor blades received at the peripheral surface of the hub; a first bearing assembly located in the hub and around a shank of a respective rotor blade to support the rotor blade in the hub under centrifugal loading and to allow the rotor blade to rotate about a longitudinal axis; and a second bearing assembly located in the hub and around a shank of a respective rotor blade and inward of the first bearing assembly to preload the first bearing assembly. A preload bearing assembly comprises an outer race; a plurality of rolling elements located therein; and a plurality of studs located in communication with the outer race. Adjustment of the studs distributes a tensile load around the outer race to exert a preload force on a bearing assembly supporting the rotor blade.

### CROSS REFERENCE TO RELATED APPLICATION

This application claims the benefit of U.S. provisional application No. 61/301,800, filed Feb. 5, 2010, the contents of which are incorporated herein by reference in their entirety.

### TECHNICAL FIELD

This invention relates in general to rotor blades and, more particularly, to rotor blades as propulsive thrust devices in aircraft and boat propellers, helicopters, and aircraft engines in which the rotor blades can be varied in pitch angle to control thrust-producing and/or power-absorbing capacities of such devices. Similar rotor blades with blade pitch angle change capability can also be used in green energy capturing devices such as wind turbines and water turbines.

### BACKGROUND

Standard configurations of rotor blades used in aircraft propellers and such that allow for variable pitch operation typically include a retention system having a rotatable root attachment means with the rotatability being effected by a mechanism such as a ball/roller bearing and/or a flexible member. Such a system allows for pitch change of the rotor blade with relatively low friction between components. To provide sufficient structural integrity (e.g., to accommodate the substantial centrifugal and/or bending forces exerted on the mechanisms during operation), the root attachment means and the mechanisms effecting the rotatability are often fabricated in such a way so as to be extremely heavy.

Some rotor blades, on the other hand, are constructed of lighter, high strength materials, which help to reduce centrifugal loads normally generated during rotation, particularly with regard to metal and/or metal/composite hybrid blade designs, thus resulting in reduced loading of the bearings. This may be of benefit in reducing the overall weight of the components used to support rotor blade loads. However, lighter bearing loads also reduce the ability of the mechanisms involved to support bending forces. Because the rotor blade retention system also affects the foundation stiffness of the rotor blade, rotor blade resonant frequencies are also influenced, which if reduced too much can lead to vibration and/or amplification of forced or self-induced vibration during operation. Thus, a reasonably high degree of stiffness in rotor blade retention systems is desired.

It is also desirable for rotor blade retention systems, especially with regard to rotor blades in heavy use applications such as those on commuter and military aircraft, to include a relatively quick and simple means of removing and replacing a single damaged rotor blade during the limited access times available for servicing the aircraft. This feature becomes more of a concern with the recent trend towards an increased number of rotor blades used per device.

### SUMMARY

In a first aspect, the present invention resides in a rotor for a propulsive thrust device. Such a rotor comprises a hub having a peripheral surface; a plurality of rotor blades received at the peripheral surface of the hub; a first bearing assembly located in the hub and around a shank of a respective rotor blade to support the rotor blade in the hub under centrifugal loading and to allow the rotor blade to rotate about a longitudinal axis; and a second bearing assembly located in the hub and around a shank of a respective rotor blade and inward of the first bearing assembly to preload the first bearing assembly.

In a second aspect, the present invention also resides in a rotor for a propulsive thrust device. Such a rotor comprises a hub having a plurality of hub arm bores located about a peripheral surface of the hub; a plurality of rotor blades mounted in the respective hub arm bores, each rotor blade being rotatable about an axis extending longitudinally through the rotor blade; a first bearing assembly located between a surface of the hub arm bore and a respective rotor blade to support the rotor blade in the hub arm bore under centrifugal loading; a second bearing assembly located between a surface of the hub arm bore and the respective rotor blade and inward of the first bearing assembly; and a stud in communication with the second bearing assembly, the adjustment of which preloads the first bearing assembly.

In a third aspect, the present invention resides in a preload bearing assembly for a rotor blade. Such a preload bearing assembly comprises an outer race; a plurality of rolling elements located in the outer race; and a plurality of studs located in communication with the outer race. Adjustment of the studs distributes a tensile load around a circumference of the outer race. The rolling elements are in rolling communication with the rotor blade, and the outer race is in communication with a hub in which the preload bearing is mounted. Distribution of the tensile load around the circumference of the outer race exerts a preload force on a bearing assembly supporting the rotor blade.

### BRIEF DESCRIPTION OF THE DRAWINGS

FIG. 1 is a perspective view of a rotor hub and rotor blade stub assembly for a propulsive thrust device.

FIG. 2 is a perspective cutaway view of the rotor hub and rotor blade stub assembly of FIG. 1.

FIG. 3A is a schematic representation of one rotor blade stub in a hub arm bore of the rotor hub and rotor blade assembly of FIG. 1 before a preload force is applied.

FIG. 3B is a schematic representation of the rotor blade stub in the hub arm bore of FIG. 1 during application of a preload force.

FIG. 3C is a schematic representation of the rotor blade stub in the hub arm bore of FIG. 1 after application of a preload force.

FIG. 4 is a perspective view of an inner preload bearing assembly and studs for the rotor of FIG. 1.

FIG. 5 is a schematic representation of a hub arm bore and a rotor blade received therein, the rotor blade being supported by an outer bearing assembly and preloaded by an inner preload bearing assembly.

### DETAILED DESCRIPTION

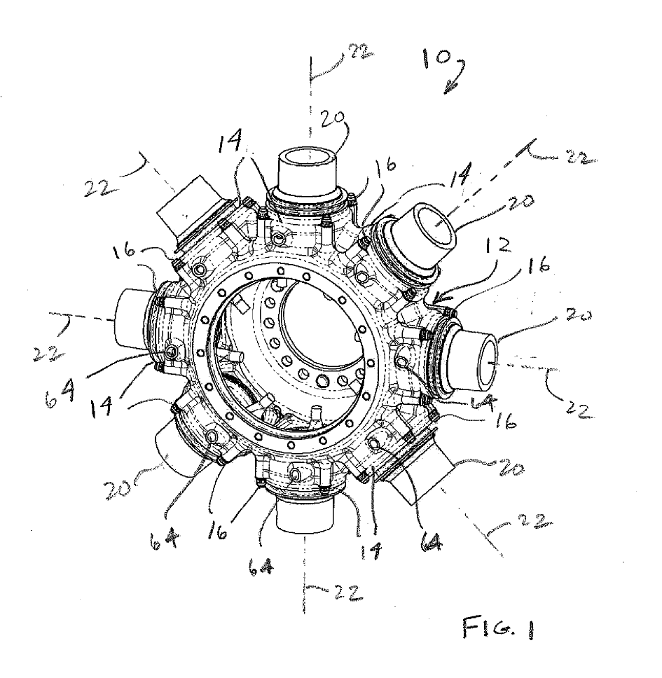

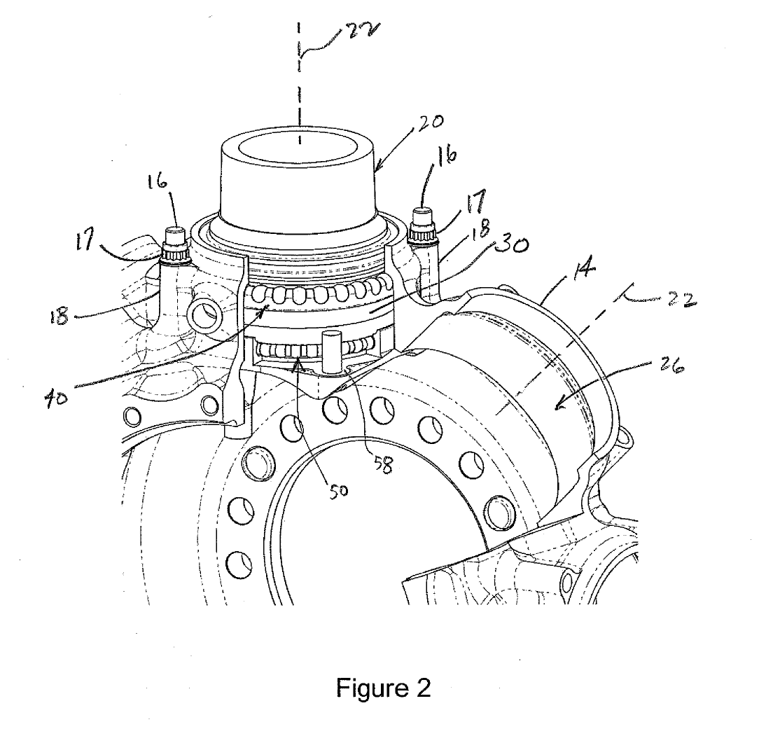

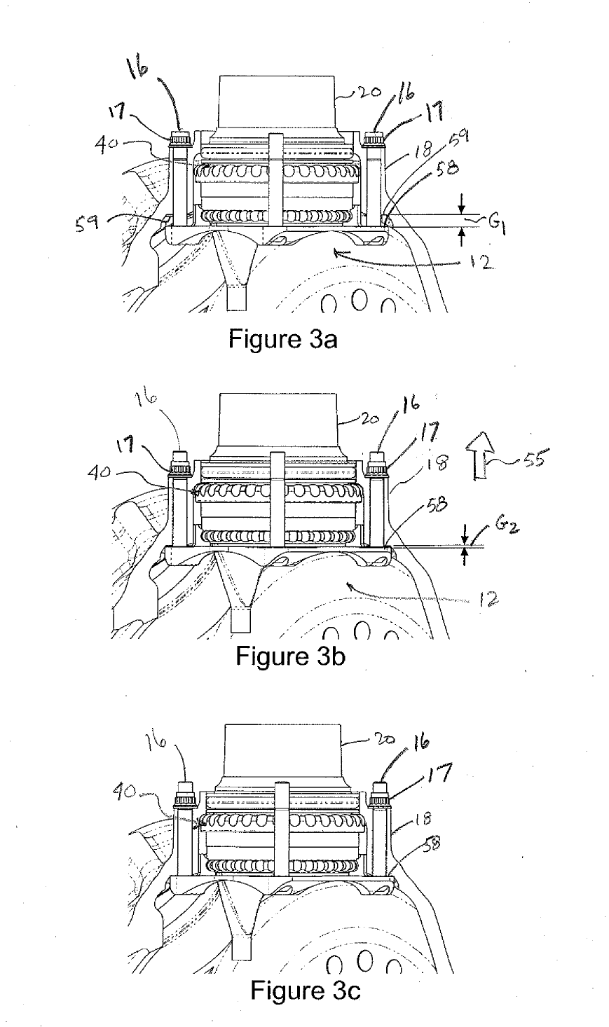

Referring to FIG. 1, a rotor for use with rotor blades for a propulsive thrust device is designated generally by the reference numeral 10 and is hereinafter referred to as “rotor 10.” Rotor 10 comprises a hub 12 having a plurality of hub arm bores 14 (or sockets or the like) equidistantly located about a peripheral surface of the hub and a plurality of studs 16 associated with each hub arm bore. The studs 16 are preferably received in bosses (shown at 18 in FIGS. 2 and 3) located around each hub arm bore 14, movable in the bosses, and can be tensioned therein via nuts (shown at 17 in FIGS. 2 and 3). A rotor blade 20 (only stubs of each rotor blade shown) is mounted in each hub arm bore 14, each rotor blade being rotatable about an axis 22 extending through the hub arm bore to effect the changing of rotor blade pitch. Movement of the studs 16 is along axes parallel to the axis 22. Tensioning the studs 16 via the nuts 17 (preferably with common drive tools) allows for both the retention of a rotor blade 20 in a respective hub arm bore and the loading of two bearing assemblies (described below as an outer bearing assembly 40 and an inner preload bearing assembly 50) associated therewith. The present invention is not limited to the incorporation of eight hub arm bores 14, as shown, as any suitable number of hub arm bores may be located about the peripheral surface of the hub 12. Furthermore, the present invention is not limited to the use of four studs 16 associated with each hub arm bore 14, as shown, as any suitable number of studs 16 may be used.

As shown in FIG. 2, each hub arm bore 14 defines a bore 26 into which a shank portion 30 of a rotor blade 20 is received. The outer bearing assembly 40 is located in each hub arm bore 14 to retain the rotor blade 20 in the bore 26 and to facilitate the rotation thereof about the axis 22 in a rotor blade pitch changing operation. The inner preload bearing assembly 50 is also located in each hub arm bore 14, each inner preload bearing assembly being adjustable via the studs 16 associated therewith. The studs 16 are elongated pin-type members extending through holes in the bosses 18, the bosses being located equidistantly around each hub arm bore 14, each stud being engageable with a tab 58 protruding from an outer race 54 of the inner preload bearing assembly 50. In the engagement of the stud 16 with the tab 58, a hexagonal shaped head, splined shank, or the like is received into a correspondingly shaped structure to prevent rotation of the stud during tensioning. The present invention is not so limited, however, as the heads of the studs may be integral with the tabs 58, or the studs may be threadedly received in the tabs. By tensioning the studs 16, the inner preload bearing assembly 50 is pulled outwardly along the axis 22, thereby preloading the outer bearing assembly 40.

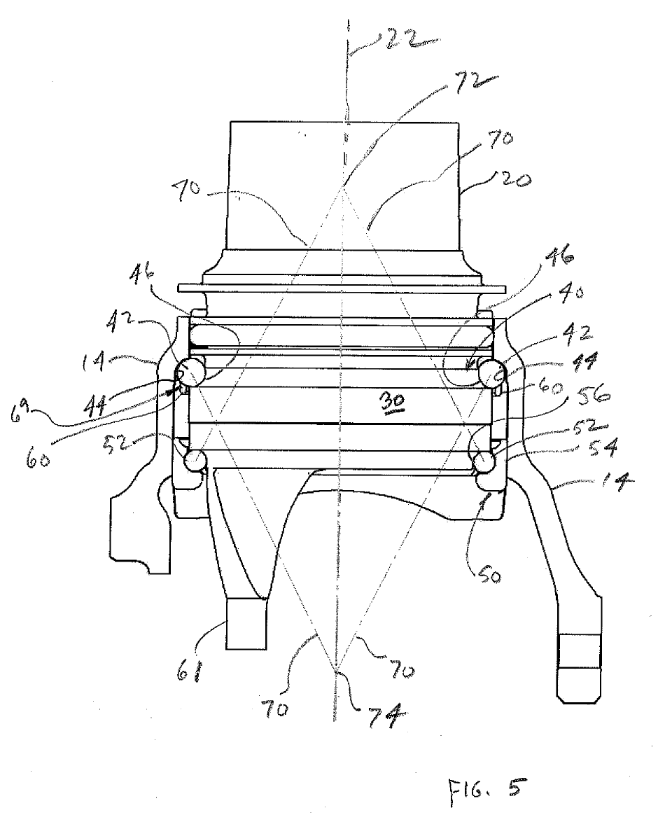

Preloading of the outer bearing assembly, as shown in FIGS. 3A, 3B, and 3C, comprises tensioning the studs 16. Before the initial tensioning of the studs 16 (FIG. 3A), the rotor blade 20 is in contact with the inner preload bearing assembly 50, and a gap G1 is present between the tabs 58 and receiving surfaces 59 in the hub arm bore 14. Upon initial tensioning of the studs 16 and pulling the inner preload bearing assembly 50 and rotor blade 20 outwardly (FIG. 3B) in the direction of arrow 55, rolling elements (shown at 42 in FIG. 5) on the inner race (also shown in FIG. 5 at 46) of the outer bearing assembly 40 are urged into initial contact with the outer race (shown in FIG. 5 at 44) formed in the hub arm bore 14 and a gap G2 is formed. Further tensioning (FIG. 3C) causes the elastic deformation of the rolling elements and races of both bearing assemblies (tabs 58 are brought into contact with receiving surfaces 59) until the gap G2 is eliminated, thereby establishing the predetermined amount of static preload between both bearing assemblies. Additional tensioning is imparted to the stud 16 by applying additional torque to inhibit separation of the tabs 58 from the receiving surfaces 59 to provide substantially constant tensile loading on the stud 16. The amount of static preload is suitably sufficient such that when significant centrifugal loading develops during operation of the rotor 10 (which can reduce the established static preload force to some degree), there is sufficient preloading remaining to inhibit the unloading of the rolling elements 52 in the inner preload bearing assembly 50 when bending loads are combined with centrifugal loading. This establishes the bending capacity of the system in operation.

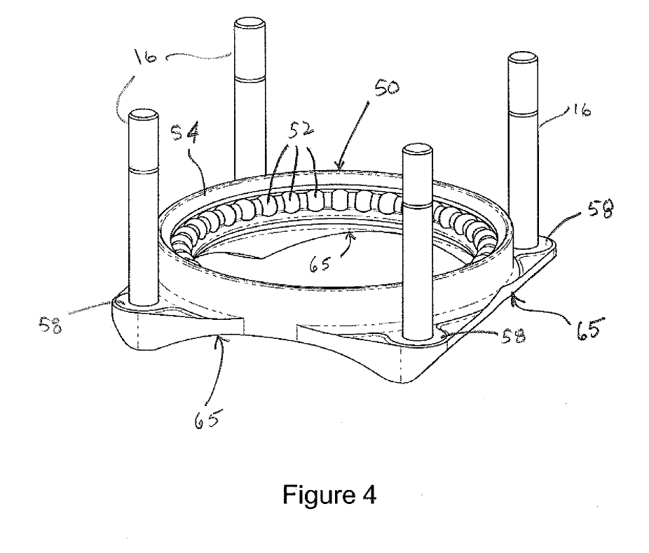

As shown in FIG. 4, the structural material of the inner preload bearing assembly 50 defines a plurality of arches 65 (or other suitable configuration) extending between each of the four tabs 58, as shown. The arches 65 facilitate the distribution of point loads around the outer race 54 when the studs 16 pull the outer race in the outward direction into a preloading position.

As shown in FIG. 5, rolling elements 42 of the outer bearing assembly 40 and rolling elements 52 of the inner preload bearing assembly 50 comprise low-friction ball bearing elements that permit, upon rotation of the rotor blade 20 about the axis 22, the pitch angle of the rotor blade to be altered when an inwardly protruding pin 61 is moved by a timing mechanism (not shown) located in the hub 12. The present invention is not limited to the use of ball bearing elements, however, as the rolling elements may be tapered roller bearings, or any other suitable type of bearing element. The rolling elements 42 of the outer bearing assembly 40 are captured between an outer race 44 defined by a machined inner surface of the hub arm bore 14 and an inner race 46 defined by a machined surface of the shank 30 of the rotor blade 20 and held therein by a cage 60. The present invention is not limited to the use of machined surfaces integral to the rotor blade and hub structure, however, as the races may be separate elements.

The cage 60 holding and supporting the rolling elements is an elongate flexible member (e.g., fabricated of a plastic material or the like) having pockets for the accommodation of the rolling elements and is referred to hereinafter as “necklace 69.” One or both ends of the necklace 69 include a tab with a hole or loop feature. Engagement of the hole or loop feature may be made with a separate hook-shaped element to withdraw the necklace 69 from the hub arm bore 14. When the necklace 69 is in the hub arm bore 14, the ring structure is formed, and the outer bearing assembly 40 is capable of being preloaded.

By tightening the nuts 17 on the studs 16, the preload force is established and the rotor 10 is operational.

When the nuts 17 are loosened to release tension on the studs 16, the preload force generated by the inner preload bearing assembly 50 is released, and the outer race 54 thereof can move further inward into the hub arm bore 14, thereby allowing the rotor blade 20 to also move inward. This unloads the outer bearing assembly 40 and provides for sufficient room around the outer bearing assembly (which is the primary bearing providing support to the rotor blade 20 and further retaining the rotor blade in place) to permit removal of the necklace 69. The necklace 69 can be pulled as an elongate element through a loading hole (shown at 64 in FIG. 1) in the side of the hub arm bore 14 located just inboard of where the outer bearing assembly 40 is located in the hub arm bore. During removal of the rotor blade 20, the inner preload bearing assembly 50 remains inside the hub arm bore 14, thereby allowing it to be protected from exposure to potential external contamination. A replacement rotor blade 20 can then be inserted into the hub arm bore 14, and the necklace 69 can be reinserted into the space defined by the outer race 44 defined by the machined inner surface of the hub arm bore 14 and the inner race 46 defined by the machined surface of the shank 30 of the replacement rotor blade 20. Once this is done, the inner preload bearing assembly 50 can be pulled back outward by tightening the studs 16 to the preset torque, thus restoring the preload between both bearing assemblies and rendering a propulsive thrust device into which the rotor 10 is incorporated ready for flight.

Also as shown in FIG. 5, angles of contact during operation of the rotor 10 are approximated by lines 70 connecting a first pair of rolling elements 52 in the inner preload bearing assembly 50 and an opposing pair of rolling elements 42 in the outer bearing assembly 40. These lines 70 define an outer focal point 72 and an inner focal point 74 for all the rolling elements in each bearing assembly. The outer focal point 72 and the inner focal point 74 are coincident with the axis 22. The distance between the inner focal point 74 and the outer focal point 72 provides a measure of the stability provided by the system of bearings defined herein by the outer bearing assembly 40 and the inner preload bearing assembly 50 in preventing bending and/or “rocking” loads from deflecting the retention of the rotor blade 20, thus augmenting a foundation stiffness for the attachment of a rotor blade 20 to the hub 12. This foundation stiffness allows resonant frequencies of the rotor blades 20 to be maintained at higher values to avoid undesirable rotor system vibration issues.

Referring now to all of the Figures, protective coatings and/or low friction sleeves can be employed to resist metal-to-metal fretting or surface wear caused by fatigue loading. The coatings and/or low friction sleeves can be provided in regions of the rotor 10 where motion under load is apt to occur. One such region is defined by the contact surfaces of the outer diameter of the inner preload bearing assembly 50 and the inner surface of the arm hub bore 14, where preferably there is a close tolerance slip fit. In this case, the hub arm bore 14 defines a surface where enhanced strength is desirable. This surface can be protected either by use of a coating thereon and/or by use of a coating on the engaging surface of the outer race 54 of the inner preload bearing assembly 50. Such a coating is preferably a thin layer of a soft metallic or plastic material such as silver plating or other material that can be applied by any suitable means, including, but not limited to, methods such as plasma spraying.

As stated above, motion between the stud 16 and the hole in the boss 18 is prevented by applying sufficient torque to the stud so that rotor blade 20 loading does not cause separation between the tabs 58 and the receiving surfaces 59.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the foregoing description.

What is claimed is:

1. A rotor for a propulsive thrust device, the rotor comprising:
a hub having a peripheral surface;
a plurality of rotor blades received at the peripheral surface of the hub;
a first bearing assembly located in the hub and around a shank of a respective rotor blade to support the rotor blade in the hub under centrifugal loading and to allow the rotor blade to rotate about a rotor blade pitch change axis extending longitudinally through the rotor blade; and
a second bearing assembly located in the hub and around the shank of the respective rotor blade and inward of the first bearing assembly to preload the first bearing assembly.

2. The rotor of claim 1, further comprising a plurality of studs located in the hub, the studs being adjustable to allow for movement of the second bearing assembly in the hub in an outward direction to preload the first bearing assembly.

3. The rotor of claim 2, further comprising a plurality of bosses located at the peripheral surface of the hub and through which the studs are received and movable along axes parallel to the rotor blade pitch change axis.

4. The rotor of claim 1, wherein the first bearing assembly comprises,
a cage defined by a length of elongate flexible material having pockets, the length of elongate flexible material being formable into a ring structure, and
rolling elements mounted in each of the pockets of the flexible material, each of the rolling elements being in rolling communication with the surface of the hub and the shanks of the rotor blades.

5. The rotor of claim 1, wherein the second bearing assembly comprises,
an outer race, and
a plurality of rolling elements located in the outer race, the rolling elements being in rolling communication with the shanks of the rotor blades.

6. The rotor of claim 5, further comprising a plurality of studs, each of which can be adjusted to distribute a tensile load around a circumference of the outer race.

7. A rotor for a propulsive thrust device, the rotor comprising:
a hub having a plurality of hub arm bores located about a peripheral surface of the hub;
a plurality of rotor blades mounted in the respective hub arm bores, each rotor blade being rotatable about an axis extending longitudinally through the rotor blade;
a first bearing assembly located between a surface of the hub arm bore and a respective rotor blade to support the rotor blade in the hub arm bore under centrifugal loading;
a second bearing assembly located between a surface of the hub arm bore and the respective rotor blade and inward of the first bearing assembly; and
a stud in communication with the second bearing assembly, the adjustment of which pulls the second bearing assembly in an outward direction to preload the first bearing assembly.

8. The rotor of claim 7, wherein the second bearing assembly comprises,
an outer race,
a tab protruding from the outer race, and
a plurality of rolling elements maintained in rolling communication with a surface of the outer race,
wherein the adjustable stud is in communication with the second bearing assembly through the tab.

9. The rotor of claim 8, wherein the outer race is configured to define a plurality of arches extending between adjacent points on the outer race, the arches being deformable via adjustment of the stud.

10. The rotor of claim 8, wherein the plurality of rolling elements is maintained in rolling communication with an inner race defined a surface of the rotor blade.

11. The rotor of claim 7, further comprising a nut located on the stud and through which the stud can be moved.

12. A preload bearing assembly for a rotor blade, the preload bearing assembly comprising:
an outer race;
a plurality of rolling elements located in the outer race;
a plurality of studs located on the outer race, the adjustment of which distributes a tensile load around a circumference of the outer race;
wherein the rolling elements are in rolling communication with the rotor blade, and the outer race is in communication with a hub in which the preload bearing is mounted; and
wherein distribution of the tensile load around the circumference of the outer race exerts a preload force on a bearing assembly supporting the rotor blade.

13. The preload bearing assembly of claim 12, further comprising a plurality of tabs protruding from the outer race, the tabs being in communication with the studs.

14. The preload bearing assembly of claim 12, further comprising a plurality of nuts in communication with the adjustable studs, the nuts being configured to provide for the movement of the studs.

15. The preload bearing assembly of claim 12, wherein the outer race is configured to define a plurality of arches deformable by the engagement of the studs with the outer race.
